(19) United States
(12) Patent Application Publication
(10) Pub. No.: US 2011/0231674 A1
(43) Pub. Date: Sep. 22, 2011

(54) INDEPENDENT DRIVE POWER CONTROL

(76) Inventors: Jason M. Stuhlsatz, Dacula, GA (US); Mohamad El-Batal, Westminster, CO (US); Keith Holt, Wichita, KS (US)

(21) Appl. No.: 12/523,509

(22) PCT Filed: Dec. 11, 2008
(86) PCT No.: PCT/US2008/086468

§ 371 Date: Jul. 16, 2009

(51) Int. Cl. G06F 1/26; G06F 11/16

(52) U.S. Cl. 713/300; 714/6.2; 714/E11.062

(57) ABSTRACT

Disclosed is a storage system enclosure. A midplane receives, from a controller coupled to the midplane, a first drive status signal and a second drive status signal. The first drive status signal and the second drive status signal are associated with a storage device. The first drive status signal indicates a fault condition associated with the storage device. The second drive status signal indicates that an action is allowed on the storage device. A drive power control supplies or removes power from the storage device in response to the state of the first drive status signal and the second drive status signal.

### BACKGROUND OF THE INVENTION

Mass storage systems continue to provide increased storage capacities to satisfy user demands. Photo and movie storage, and photo and movie sharing are examples of applications that fuel the growth in demand for larger and larger storage systems.

A solution to these increasing demands is the use of arrays of multiple inexpensive disks. These arrays may be configured in ways that may provide redundancy and error recovery without any loss of data. These arrays may also be configured to increase read and write performance by allowing data to be read or written simultaneously to multiple disk drives. These arrays may also be configured to allow “hot-swapping” which allows a failed disk to be replaced without interrupting the storage services of the array. Multiple disk storage systems typically utilize a controller that shields the user or host system from the details of managing the storage array. The controller may make the storage array appear as one or more disk drives (or volumes). This is accomplished in spite of the fact that the data (or redundant data) for a particular volume may be spread across multiple disk drives.

To facilitate the development and deployment of these multiple disk storage systems, several specifications have been developed. These specifications are promulgated by the Storage Bridge Bay Working Group, Inc. In particular, the Storage Bridge Bay Working Group, Inc. has promulgated the Storage Bridge Bay (SBB) Specification, Version 2.0, Jan. 28, 2008 available at www.sbbwg.org. This specification aims to define common mechanical, electrical, and internal interfaces between a storage enclosure and the electronics cards that give the system a function. The ultimate aim of the SBB specification is to allow multiple different controllers to be used in a single, standard compliant, chassis to change the “personality” of the storage array.

### SUMMARY OF THE INVENTION

An embodiment of the invention may therefore comprise a storage system enclosure, comprising: a midplane receiving, from a controller coupled to said midplane, a first drive status signal and a second drive status signal, said first drive status signal and said second drive status signal being associated with a first drive that is coupled to said midplane, said first drive status signal indicating a fault condition associated with said first drive, said second drive status signal indicating that an action is allowed; a drive power control that removes power from said first drive in response to said first drive status signal and said second drive status signal.

An embodiment of the invention may further comprise a method of controlling power to a storage device, comprising: receiving a first drive status signal from a controller; receiving a second drive status signal from said controller; based on said first drive status signal, controlling a first luminescent indicator associated with an action required on said storage device; based on said second drive status signal, controlling a second luminescent indicator associated with an action allowed on said storage device; based on said first drive status signal and said second drive status signal, providing power to said storage device.

### BRIEF DESCRIPTION OF THE DRAWINGS

FIG. 1 is a block diagram of a storage system.

FIG. 2 is a flowchart of a method of controlling power to a storage device.

FIG. 3 is a flowchart of a method of denying and providing power to a storage device.

FIG. 4 is a block diagram of a computer system.

### DETAILED DESCRIPTION OF THE EMBODIMENTS

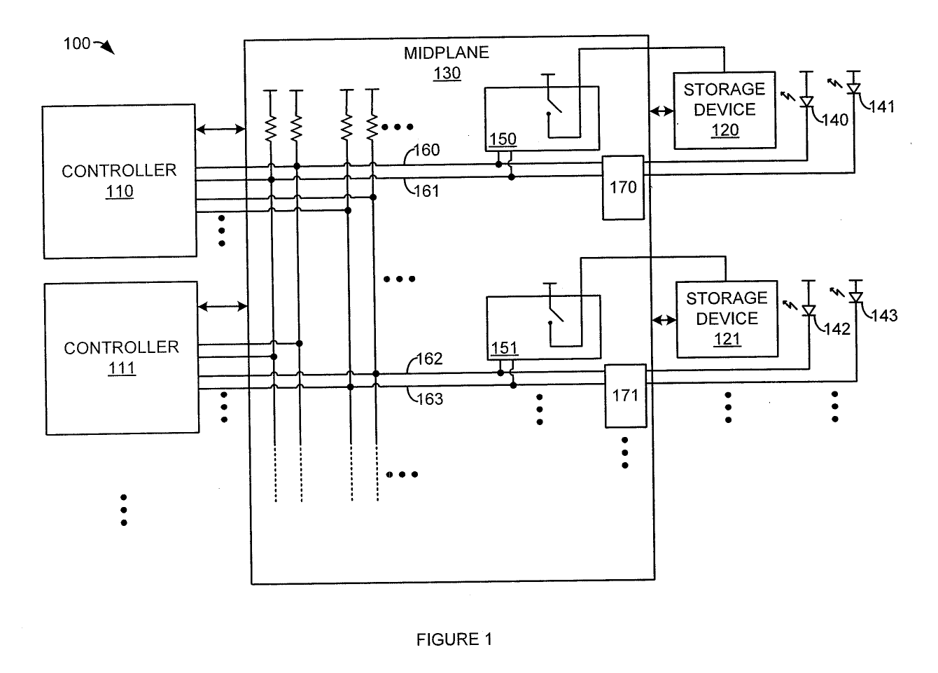

FIG. 1 is a block diagram of a storage system. In FIG. 1, storage system 100 comprises: controller 110, controller 111, storage device 120, storage device 121, midplane 130, luminescent devices 140-143, power control 150, power control 151, drive status signals 160-163, and luminescent device drivers 170-171. Controllers 110-111 are operatively coupled to midplane 130. Storage devices 120-121 are operatively coupled to midplane 130. Thus, controllers 110-111 may operatively connect or exchange information with storage devices 120-121 via midplane 130. Controllers 110-111 may operatively connect with, or exchange that information with, other devices (not shown) that are coupled to storage system 100. Storage system 100 may comprise additional controllers. Storage system 100 may comprise additional storage devices. However, these have been omitted from FIG. 1 for the sake of brevity.

Storage system 100 may be, or comprise, a system that conforms to the SBB specification. Thus, controllers 110-111 may be, or comprise, controllers that are compatible with or described by, for example, InfiniBand, Just a Bunch Of Disks or Just a Box Of Drives (JBOD), Redundant Array of Inexpensive Disks (RAID), Network Attached Storage (NAS), Storage Array Network (SAN), iSCSI SAN, or a Virtual Tape Library (VTL). Thus, storage devices 120-121 may be, or comprise, hard disk drives. Storage devices 120-121 may be, or comprise, other types of drives such as solid state disk drives, tape drives, and ROM drives. Other types of storage devices are possible.

Luminescent devices 140-143 may be, or comprise, indicators that are visible to a user of storage system 100. For example, luminescent devices 140-143 may be, or comprise, a light bulb or light emitting diode (LED) that provides an indication or information to a user about the status of one or more elements of storage system 100. In an embodiment, luminescent devices 140-143 may be controlled by luminescent device drivers 170-171. However, it should be understood that luminescent device drivers 170-171 are optional and that luminescent devices 140-143 may be controlled directly by controllers 110 or 111.

In an embodiment, controller 110 may supply drive status signal 160 to midplane 130. Drive status signal 160 may be associated with an action on storage device 120 being required. Drive status signal 160 may be forwarded by midplane 130 to luminescent device driver 170 to control luminescent device 140. The state of luminescent device 140 (i.e., “on” or “off”) may be visible on the exterior of storage system 100. The state of luminescent device 140 may indicate to a user that an action is required on storage device 120. For example, when luminescent device 140 is on, it may indicate to a user that a service action is required. In an embodiment, drive status signal 160 may correspond to a low-speed drive status signal as defined in the SBB specification. In particular, drive status signal 160 may correspond to a Drive_X_Fault_L signal defined in the SBB specification, where X is a number corresponding to storage device 120.

Controller 110 may supply drive status signal 161 to midplane 130. Drive status signal 161 may be associated with an action being allowed on storage device 120. Drive status signal 161 may be forwarded by midplane 130 to luminescent device driver 170 to control luminescent device 141. The state of luminescent device 141 may be visible on the exterior of storage system 100. The state of luminescent device 141 may indicate to a user that an action is allowed on storage device 120. For example, when luminescent device 141 is on, it may indicate to a user that a particular service action is allowed. That service action may include replacing or “hot swapping” storage device 120. In an embodiment, drive status signal 161 may correspond to a low-speed drive status signal as defined in the SBB specification. In particular, drive status signal 160 may correspond to a Drive_X_GPO_L signal defined in the SBB specification, where X is a number corresponding to storage device 120.

Controller 110 may also supply drive status signals 162-163 to midplane 130. Drive status signals 162-163 may be associated with storage device 121. Drive status signals 162 and 163 may correspond to a service action being required and service action being allowed on storage device 121, respectively. Drive status signals 162 and 163 may be provided by midplane 130 to luminescent device driver 171 to control luminescent devices 142 and 143, respectively. The state of luminescent devices 142 and 143 may be visible on the exterior of storage system 100. The state of luminescent devices 142 and 143 may indicate to a user that an action is required, or allowed, on storage device 121. Drive status signals 162 and 163 may correspond to low-speed drive status signals as defined in the SBB specification. In particular, drive status signals 162 and 163 may correspond to a Drive_X_Fault_L and a Drive_X_GPO_L signal, respectively, as defined in the SBB specification, where X is a number corresponding to storage device 121.

In an embodiment, controller 111 may also control drive status signals 160-163. In this case, midplane 130 may logically combine the drive status signals 160-163 received from controllers 110-111 (and other controllers, not shown). For example, midplane 130 may connect the drive status signal 160-163 received from controller 110 and the drive status signals received from controller 111 in a “wired-OR” fashion to logically OR them. It should be understood that other ways of logically combining multiple drive status signals 160-163 received from multiple controllers 110-111 are possible.

Midplane 130 provides power to storage device 120. Midplane 130 provides power to storage device 121. In an embodiment, midplane 130 includes power control 150 and power control 151. Power control 150 is configured to control (i.e., provide or deny) power to storage device 120. Power control 151 is configured to control power to storage device 121. Midplane 130 may comprise additional power controls (not shown) that control the power to additional storage devices (not shown). However, these have been omitted from FIG. 1 for the sake of brevity. Power controls 150-151 may comprise a switching device that can connect and disconnect a power supply to storage devices 120-121. For example, power controls 150 or 151 may comprise a power MOSFET, bipolar transistor, relay, or other switching device that can selectively provide and deny power to storage devices 120 and 121, respectively.

In an embodiment, power control 150 receives drive status signals 160 and 161. Drive status signals 160-161 may be used by power control 150 to control the power to storage device 120. For example, when drive status signals 160 and 161 are both active, then power control 150 may deny (or remove) power to storage device 120. When either of drive status signals 160 or 161 is inactive, then storage device 120 is supplied power by power control 150. As a result, when both luminescent devices 140 and 141 are on, the power to storage device 120 is off. Power control 151 may function in a similar manner under the control of drive status signals 162-163. Likewise, when both luminescent devices 142 and 143 are on, the power to storage device 121 is off.

In an embodiment, controller 110 or controller 111 may use the states of drive status signals 160-163 to reset storage devices 120-121. For example, controller 110 may be operating with either drive status signal 160 or 161 in an inactive state. Thus, power control 150 will be supplying power to storage device 120. Controller 110 may then set both drive status signals 160 and 161 into an active state. This causes power control 150 to remove power to storage device 120. After a period of time sufficient to cause a reset of storage device 120, controller 110 may set at least one of drive status signals 160 or 161 to an inactive state. This causes power control 150 to restore power to storage device 120. The interruption of power causes storage device 120 to reset or restart itself.

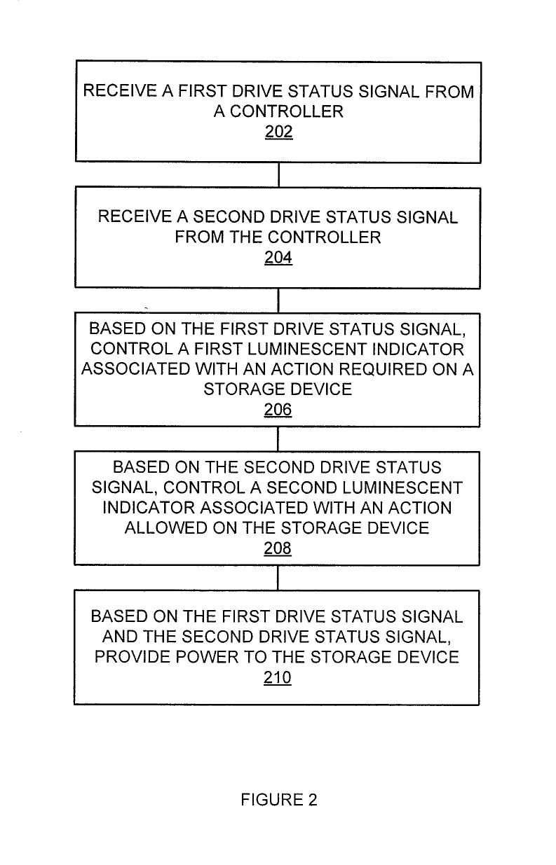

FIG. 2 is a flowchart of a method of controlling power to a storage device. The steps illustrated in FIG. 2 may be performed by one or more elements of storage system 100.

A first drive status signal is received from a controller (202). For example, midplane 130 may receive drive status signal 160 from controller 110. A second drive status signal is received from the controller (204). For example, midplane 130 may receive drive status signal 161 from controller 110.

Based on the first drive status signal, a first luminescent indicator that is associated with an action required on a storage device is controlled (206). For example, luminescent device 140 may be associated with a service action required on storage device 120. Luminescent device 140 may be controlled by midplane 130 in response to the first drive status signal received from controller 110.

Based on the second drive status signal, a second luminescent indicator that is associated with an action allowed on a storage device is controlled (208). For example, luminescent device 141 may be associated with a service action allowed on storage device 120. Luminescent device 141 may be controlled by midplane 130 in response to the second drive status signal received from controller 110.

Based on the first drive status signal and the second drive status signal, power is provided to the storage device (210). For example, in response to either the first drive status signal and the second drive status signal being inactive, midplane 130, using power control 150, may provide power to storage device 120. If both the first drive status signal and the second drive status signal are active, then midplane 130, using power control 150, may deny or remove power to storage device 120.

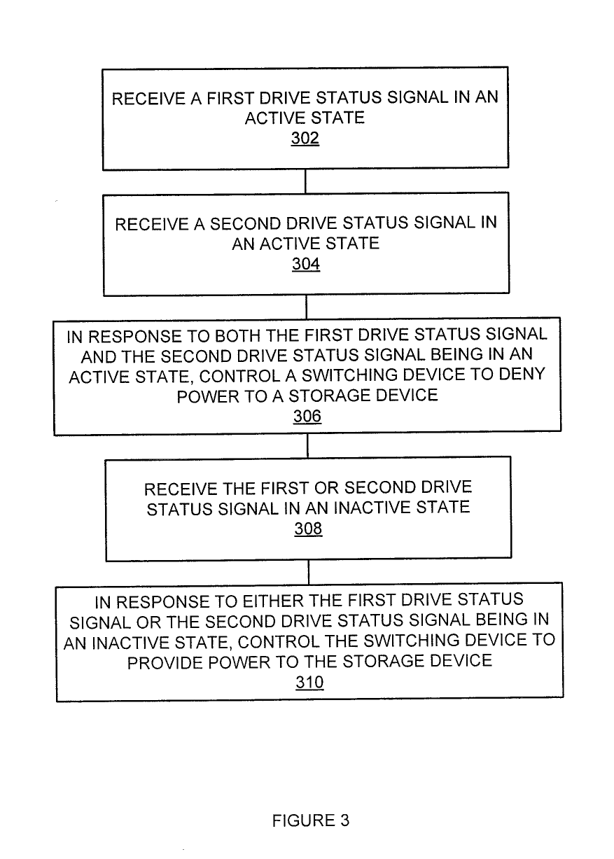

FIG. 3 is a flowchart of a method of denying and providing power to a storage device. The steps illustrated in FIG. 3 may be performed by one or more elements of storage system 100.

A first drive status signal is received in an active state (302). For example, midplane 130 may receive drive status signal 160 from controller 110 in an active state. A second drive status signal is received in an active state (304). For example, midplane 130 may receive drive status signal 161 from controller 110 in an active state.

In response to both the first drive status signal and the second drive status signal being in an active state, a switching device is controlled to deny power to a storage device (306). For example, in response to drive status signal 160 and drive status signal 161 being in an active state, midplane 130, using power control 150, may control a switching device to deny power to storage device 120.

The first or second drive status signal (or both) is received in an inactive state (308). For example, either, or both of drive status signal 160 or 161 may be received by midplane 130 from controller 110 in an inactive state. In response to either the first drive status signal or the second drive status signal being in an inactive state, the switching device is controlled to provide power to the storage device (310). For example, in response to drive status signal 160 or drive status signal 161 (or both) being in an inactive state, midplane 130, using power control 150, may control a switching device to provide power to storage device 120.

The methods, systems, networks, devices, equipment, and functions described above may be implemented with or executed by one or more computer systems. The methods described above may also be stored on a computer readable medium. Many of the elements of storage system 100, may be, comprise, or include computers systems. This includes, but is not limited to controller 110, controller 111, storage device 120, storage device 121, midplane 130, power control 150, and power control 151.

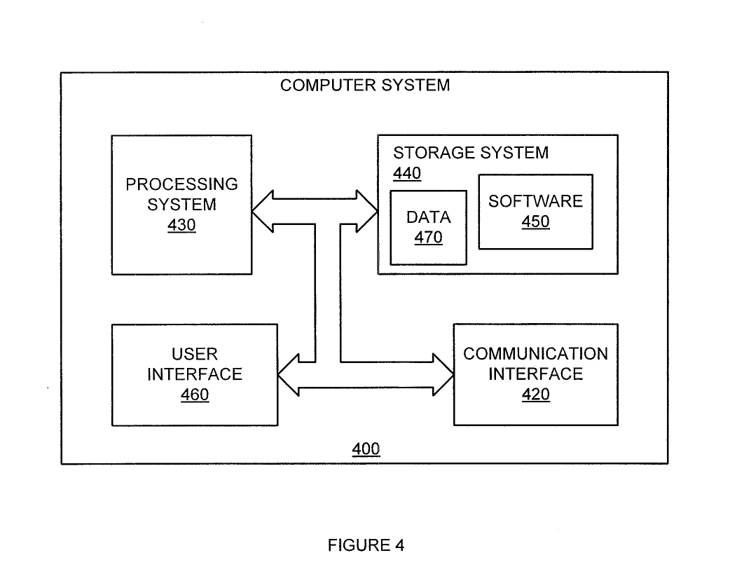

FIG. 4 illustrates a block diagram of a computer system. Computer system 400 includes communication interface 420, processing system 430, storage system 440, and user interface 460. Processing system 430 is operatively coupled to storage system 440. Storage system 440 stores software 450 and data 470. Processing system 430 is operatively coupled to communication interface 420 and user interface 460. Computer system 400 may comprise a programmed general-purpose computer. Computer system 400 may include a microprocessor. Computer system 400 may comprise programmable or special purpose circuitry. Computer system 400 may be distributed among multiple devices, processors, storage, and/or interfaces that together comprise elements 420-470.

Communication interface 420 may comprise a network interface, modem, port, bus, link, transceiver, or other communication device. Communication interface 420 may be distributed among multiple communication devices. Processing system 430 may comprise a microprocessor, microcontroller, logic circuit, or other processing device. Processing system 430 may be distributed among multiple processing devices. User interface 460 may comprise a keyboard, mouse, voice recognition interface, microphone and speakers, graphical display, touch screen, or other type of user interface device. User interface 460 may be distributed among multiple interface devices. Storage system 440 may comprise a disk, tape, integrated circuit, RAM, ROM, network storage, server, or other memory function. Storage system 440 may be a computer readable medium. Storage system 440 may be distributed among multiple memory devices.

Processing system 430 retrieves and executes software 450 from storage system 440. Processing system may retrieve and store data 470. Processing system may also retrieve and store data via communication interface 420. Processing system 450 may create or modify software 450 or data 470 to achieve a tangible result. Processing system may control communication interface 420 or user interface 470 to achieve a tangible result. Processing system may retrieve and execute remotely stored software via communication interface 420.

Software 450 and remotely stored software may comprise an operating system, utilities, drivers, networking software, and other software typically executed by a computer system. Software 450 may comprise an application program, applet, firmware, or other form of machine-readable processing instructions typically executed by a computer system. When executed by processing system 430, software 450 or remotely stored software may direct computer system 400 to operate as described herein.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A storage system enclosure, comprising:
a midplane receiving, from a controller coupled to said midplane, a first drive status signal and a second drive status signal, said first drive status signal and said second drive status signal being associated with a first drive that is coupled to said midplane, said first drive status signal indicating a fault condition associated with said first drive, said second drive status signal indicating that an action is allowed; and,
a drive power control that removes power from said first drive in response to said first drive status signal and said second drive status signal.

2. The storage system enclosure of claim 1, wherein said drive power control removes power from said first drive in response to said first drive status signal and said second drive status signal both being active.

3. The storage system enclosure of claim 1, wherein said first drive status signal controls a first luminescent device and said second drive status signal controls a second luminescent device.

4. The storage system enclosure of claim 1, wherein said drive power control comprises a power field-effect transistor that operatively connects and disconnects a power supply from said first drive.

5. The storage system enclosure of claim 3, wherein said first luminescent device and second luminescent device are light emitting diodes visible on an exterior of said storage system enclosure.

6. The storage system enclosure of claim 5, wherein said first luminescent device corresponds to an indication of service action required and said second luminescent device corresponds to an indication of service action allowed.

7. The storage system enclosure of claim 1, wherein said controller uses said first drive status signal and said second drive status signal to reset said first drive.

8. A method of controlling power to a storage device, comprising:
receiving a first drive status signal from a controller;
receiving a second drive status signal from said controller;
based on said first drive status signal, controlling a first luminescent indicator associated with an action required on said storage device;
based on said second drive status signal, controlling a second luminescent indicator associated with an action allowed on said storage device; and,
based on said first drive status signal and said second drive status signal, providing power to said storage device.

9. The method of claim 8, wherein providing power to said storage device is based on said first drive status signal and said second drive status signal being active.

10. The method of claim 8, wherein said first luminescent indicator and said second luminescent indicator are light-emitting diodes visible on an exterior of said storage device.

11. The method of claim 8, further comprising:
receiving said first drive status signal in an active state;
receiving said second drive status signal in said active state;
in response to both said first drive status signal and said second drive status signal being in said active state, controlling a switching device to deny power to said storage device.

12. The method of claim 11, wherein said switching device is a field effect transistor.

13. The method of claim 11, further comprising:
receiving said first drive status signal in an inactive state;
in response to said first drive signal being in said inactive state, controlling said switching device to provide power to said storage device.

14. The method of claim 11, further comprising:
receiving said second drive status signal in an inactive state;
in response to said second drive signal being in said inactive state, controlling said switching device to provide power to said storage device.
